(19) United States
(12) Patent Application Publication
(10) Pub. No.: US 2024/0286190 A1
(43) Pub. Date: Aug. 29, 2024

(54) CO-SINTERING

(71) Applicant: QDOT TECHNOLOGY LTD, Didcot, Oxfordshire (GB)

(72) Inventors: Alasdair MORRISON, Didcot, Oxfordshire (GB); Tsun Holt WONG, Didcot, Oxfordshire (GB); Jack Robert NICHOLAS, Didcot, Oxfordshire (GB)

(21) Appl. No.: 18/571,491

(22) PCT Filed: Jun. 24, 2022
(86) PCT No.: PCT/GB2022/051638

§ 371 Date: Dec. 18, 2023

(30) Foreign Application Priority Data
Jun. 25, 2021 (GB) 2109230.9

(51) Int. Cl. B22F 3/10; B22F 5/10; B22F 7/06; B33Y 10/00; B33Y 80/00

(52) U.S. Cl. CPC B22F 3/1017; B22F 5/10; B22F 7/062; B22F 2998/10; B33Y 10/00; B33Y 80/00

(57) ABSTRACT

The present invention includes a novel sintered component (1) and a method of production thereof. The method including creating (100) a plurality of sub¬components (10) using binder jetting additive manufacturing; the sub-components (10) having an outer surface (20) including one or more protruding portions (22, 24) having one or more bonding faces (26) configured to interface with at least one of the one or more bonding faces (26) of a neighbouring sub-component (1) and a recessed portion (28) for defining a cavity (30), in the sintered component (1), between sub-components (10); heating the plurality of sub-components (10) in a first heating step (104); assembling (106) said sub-components (10); heating the assembly of sub-components in a second heating step (108).

### FIELD

The present invention relates to thin walled sintered components and methods of producing the same. More particularly, the present invention relates to co-sintered modular structures and methods of producing the same.

### BACKGROUND

Components produced by powder processes must be sintered to enable a shaped powder pre-form to consolidate into a bulk material. Producing parts by sintering of a powder material is well known and involves forming a component from a powdered material normally with a binder to allow it to maintain its form. This is known as a green body. The binder is then partially removed to increase the percentage of powder material in the final component in a process known as debinding. Once removed the component is known as a brown body; a brown body is a body ready for sintering. Alternatively, the powder compact may be produced using a non-consumable functional binder product as described in EP3661673A1, avoiding the green-body stage.

The brown body is sintered by heating causing the particles of the power material to coalesce to form a homogenous component. The final density of the component is governed by how much the brown body is sintered through the duration and temperature of the heating and is denoted by the percentage of the density of the pure powder material. i.e. if the final component has half the density of the material of the powder material it will be known as 50% density and the same density and the material of the powder material 100% or fully sintered.

One method of creating the green body is to use powder bed manufacturing processes such as binder-jet additive manufacturing. Binder-Jet additive manufacturing works by building a component up in layers. A layer of powder material is spread across a complete area of a build platform and a binder is added to the powder over the cross section of the part to bind the powder together in that cross section. A further layer of powder is added, and binder added to the powder over the cross section of the part once again. The binder both binds the powder of the subsequent layer required for the part and the subsequent layer to the previous layer. This process is repeated until the component has reached its full height, leaving the component contained in a body of unused powder material. Excess powder that has not had binder added remains free to move and must be removed before the component is sintered to prevent it being included in the final component during the sintering process. During sintering the component is heated and particles of powder coalesce to form the final component. As the voids between the powder particles are reduced or removed during the sintering process the final sintered component is smaller than the green or brown body.

Sintering, in particular the sintering of brown bodies created by Binder-Jet additive manufacturing, also known as binder jetting, are limited in size and/or complexity. The more complex a part the more limited the size that can be produced using the above sintering process. Binder jetting in particular is limited in the physical dimensions of a component it can build to the order of 60 mm in any one direction. Larger parts suffer from fracture during sintering where the shrinkage across the length of the features results in stresses leading to fracture. Thus, it is not possible to manufacture larger items using conventional binder jetting manufacture methods.

High resolution additive manufacture considered here as a minimum wall thickness of less than 0.2 mm requires the use of powder bed manufacturing processes such as binder jetting where the powder is joined together to make a heterogeneous bulk material. When manufacturing the green body using powder bed manufacturing, if there are internal voids in the design, the manufacturing process necessitates that these voids are filled with powder at the end of the initial powder joining process. This can be challenging or impossible to remove. In the method, of the current invention these internal voids can be moved to the surface of the green body which can then be joined to a complementary green body to form a homogenous component. This reduces the minimum channel diameter that can be achieved, allows comparatively large cavities with small apertures and intricate detail on internal cavity surfaces, that would otherwise hold powder, as the powder can be removed from open regions without any difficulty.

Powder bed binder jetting, in particular with metal powder material, allows high resolution parts with comparatively small scale overall component dimensions. Current techniques that allow larger components to be produced do not allow high resolution features to be realised without high cost, complex subtractive machining, or chemical processing to remove excess material.

Removal of excess powder after the Binder-Jet additive manufacturing process is also difficult or impossible if there are intricate internal cavities especially if those cavities have a small opening, include internal surface detail, or form non-linear passages through the component.

Thus, the current invention addresses two major challenges in the manufacture of highly detailed, large parts by additive manufacturing:
1. Allowing the implementation of the binder jetting processes to produce components of greater size than the limitations placed on the process by sintering.
2. Reducing the challenges of powder removal, allowing thin section tubing and thin walled features to be used.
3. Combining high resolution features with large overall dimensions.

Thin walled for binder-jetted components can be considered to be below 2 mm, however, 0.45 mm is possible for walls and 0.1 mm for non-fluid retaining structures such as fins for heat dissipation are possible.

Particularly beneficial applications of the method of the current invention include:

High efficiency heat exchangers to transfer thermal energy between a liquid and a gas, two liquids, or two gases. In order to achieve the scale of thermal energy transfer required in high efficiency heat exchangers, for the majority of applications the maximum dimensions of the exchanger will be considerably larger than can be currently achieved using binder jetting. One example being for the coolant of lubricant oils for the gearbox of an ultra-high bypass ratio turbofan. A second example being in the design of two-phase flow heat exchangers such as condensers or evaporators. Where the large surface area of enclosed volumes promotes high efficiency phase changes.

The method is also suitable for the production of high complexity structures for heat sinks. Such examples include heat sinks for power electronics devices, nuclear fusion heatsinks, and battery cooling heatsinks.

A heat exchanger's efficiency is governed by how much heat energy the heat exchanger can transfer from one gas or liquid, together herein referred to as a fluid, to another fluid in a given volume. The factors that influence this efficiency are the surface area of the heat exchange surfaces exposed to the fluids, the speed and type of flow through the core, and the thermal mass of the heat exchanger.

Traditionally heat exchangers and specifically the cores of heat exchangers comprise aluminium or other metal tubes with high thermal conductivity through which a fluid flows and fins on the outer surface to increase surface area for transfer of heat on the outside of these tubes. Such fins must be joined to the tubes, the fins and the joins unavoidably increase thermal mass and reduce the speed at which heat is transferred between the fluids. The shape of traditional heat exchangers is also constrained by their construction techniques. Tubes are inherently straight and sheet material from which the fins are made are inherently flat, therefore achieving intricate shapes, in particular shapes with compound curvature is difficult as is a non-uniform structure. These, arrangements also provide little scope for flow control especially within the tubes.

The current invention allows a heat exchanger to be created with a novel structure having lower thermal mass, increased surface area to volume and control over the flow type and path of each fluid travelling through the core. All with the further advantage that the heat exchanger can be produced to be in any shape.

### SUMMARY OF INVENTION

Aspects and/or embodiments of the current invention seek to provide an improved method of producing a component produced by a powder process. In particular a component using binder jetting additive manufacture techniques.

According to a first aspect, there is provided a method for making a thin walled, sintered component comprising, creating a plurality of sub-components using binder jetting additive manufacturing, heating the plurality of sub-components in a first heating step to at least partially sinter the sub-components, assembling said sub-components to form an assembly of sub-components, having one or more bonding interfaces where the bonding faces of adjacent sub-components meet, and heating the assembly of sub-components in a second heating step to bond the sub-components together to form the component.

Said sub-components comprising a shaped powder preform, including a powder material and a binder. The sub-components having an outer surface including one or more protruding portions having one or more bonding faces configured to interface with at least one of the one or more bonding faces of a neighbouring sub-component. The sub components may also include a recessed portion for defining a cavity, in the sintered component, between sub-components.

In an embodiment, sintered sub-components joined during the second heating step can provide a sintered component of greater size and complexity than available using processes of the prior art. In particular shapes that include intricate internal detail or passages.

Optionally, the first heating step partially sinters the sub-component and the second heating phase further sinters the component.

In some embodiments partially sintering the sub-component in the first heating step advantageously, allows the advantages listed above to be achieved whilst maintaining a lower density in the sintered component

Optionally, the first heating step comprises fully sintering the sub-components.

In some embodiments, full sintering of the sub-component during the first heating step can provide improved accuracy at the bonding interfaces and enhance intimate contact for improving the bonding between sub-components in the second heating step.

Optionally, the sub-components further include an inner surface defining a first passage, a first end and a second end; the first passage extending from said first end to said second end through the sub-component, and having a central axis A extending from the first end to the second end.

Optionally, the sub-component includes a first protruding portion of the respective sub-component extends radially at or near the first end and a second protruding portion of the respective sub-component extends radially at or near the second end and said protruding portions tesselate at their respective bonding faces in the sintered component such that the cavity forms a second passage perpendicular to the central axes A.

Optionally, the second heating step includes sealing the bonding interface between the subcomponents such that the first passage and/or the second passage are individually fluid tight.

In some embodiments, sealing of the bonding interface between sub-components so that the interface is fluid tight allows the first passage and/or the second passage to be individually fluid tight and therefore provide a fluid tight first and second fluid flow path respectively. For example, in the case where the sintered component is a fluid to fluid heat exchanger.

Optionally, the protruding portions are created having external planar faces which define a polygon in cross section and said external faces are the bonding faces, advantageously providing a close interface between the bonding faces of adjacent sub-components in the assembly of sub-components.

Optionally, the method includes the step of partially debinding the sub-components before the second heating step.

In some embodiments, debinding the sub-components before the second heating step which includes debinding the components before the first heating step advantageously provides a sintered component with a higher percentage of the powder material that may improve the properties of the sintered component.

Optionally, the assembly of sub-components further includes the step of adding a bonding material at the bonding interfaces between the sub-components before the second heating step. Further, optionally the bonding material may comprise further powder material or a mixture of further powder material and further binder.

In some embodiments, adding further powder material or powder material and binder may improve the strength of the bond at the bonding interface.

Optionally, wherein a non-powder processed functional structure is added to the sub-component before assembly of the sub-components to form the assembly of sub-components. The non-powder processed functional structure may be a foil structure.

In some embodiments, the inclusion of a non-powder processed structure can provide structural improvements in the sintered component, or functional benefits such as improved or increased surface area for heat transfer or modification of fluid flow characteristics around or through the sintered component.

Optionally, wherein the adding of the non-powder structure includes a supplementary heating step for bonding the non-powder structure to the sub-component.

Optionally, a compressive force is applied to the bonding interfaces between the sub-components during the second heating step. Further optionally, the bonding faces of the sub-components may be arranged such that gravity provides said compressive force.

Further optionally, the assembly of sub-components is placed in a fixture for the second heating step for providing the compressive force. The fixture may have a coefficient of thermal expansion lower than the material of the component for providing the compressive force at the bonding interfaces. The fixture may optionally include an anti-diffusion coating to prevent adhesion of the component to the fixture.

In some embodiments, providing a compressive force at the bonding interfaces during the second heating step advantageously improves the strength of the bond between the sub-components in the sintered component.

Optionally, the sub-components are sintered to 80-100% of full density during the first heating step.

Optionally, the sub-components are sintered to 98-100% of full density during the first heating step.

Optionally, wherein the sub-components are sintered to 80-95% of full density during the first heating step.

Optionally, the sub-components are sintered to 95-99% of full density during the first heating step.

In further aspects, the invention seeks to provide a unitary thin walled sintered component with greater detail and a more complex internal structure.

According to a second aspect of the invention a unitary, thin walled, heat exchanger core is provided that may comprise a sintered material having:
a plurality of first passages each having a first end, a second end, an inner surface and an outer surface;
the inner surface connecting the first end and second end; a wall extending between the outer surface and the inner surface;
and each first passage defining a central axis A extending from the first end to the second end;
the outer surface including a first protruding portion at or near the first end and a second protruding portion at or near the second end,
the first protruding portion extending radially and the second protruding portion extending radially and each connected to one or more neighbouring sub-components at a bonded interface, and
the outer surface further including a recessed portion defining a cavity between the plurality of first passages; wherein
the cavity is a second passage perpendicular to the central axis A

Optionally the first protruding portions and second protruding portions tessellate at their respective bonding interfaces and said bonding interfaces are continuous such that the first passage and/or the second passage are separate and fluid tight.

Optionally the first passage provides a first fluid flow path, and the second passage provides a second fluid flow path separate and perpendicular to the first fluid flow path.

Optionally each first passage has a polygonal cross section extending along the axis A.

Optionally the inner surface and/or outer surface of one or more of the first passages includes further protrusions for increasing surface area or adjusting fluid flow characteristics such as fins, complex fins, protrusions or triply periodic minimal surface lattice structures.

Optionally including a non-powder process structure within the first passage and/or second passage bonded to the inner surface or outer surface respectively for improving heat transfer or directing fluid flow.

Optionally, the non-powder process structure comprises a plurality of foil sheets arranged in the first passage or second passage.

Optionally, the heat exchanger core is a cellular structure, and each of the first passages forms a cell and said cellular structure comprises a plurality of non-uniform cells arranged to enhance heat transfer by manipulating fluid flow in the second passage.

Optionally, the first protruding portion extending radially and connected to a first protruding portion of a neighbouring first passage and the second protruding portion extending radially and connected to a second protruding portion of a neighbouring first passage at the bonded interface. Optionally, the first and second protruding portions are connected to one or more first and second protruding portions of neighbouring first passages respectively.

Optionally, each first passage comprises a polygonal wall extending between the inner surface and the outer surface. Further Optionally a first aperture having a first perimeter at the first end and a second aperture having a second perimeter at the second end connected by the first passage, the first protruding portion, extending from the first perimeter and the second protruding portion extending from the second perimeter to the bonding interface wherein the bonding interface has a polygon cross-section.

Optionally, the sintered material is a pure metal, alloy, ceramic, or composite that can be sintered.

According to a further aspect there is provided a unitary, thin walled, sintered component manufactured according to the method of the current invention, formed of a plurality of bonded sub-components. Each sub-component has a first end, a second end, an inner surface, and an outer surface. Each subcomponent may also have a first passage defined by the inner surface connecting the first end and the second end and said first passage defining a central axis A extending from the first end to the second end (14).

The outer surface may include a first protruding portion at or near the first end and a second protruding portion at or near the second end, the first and second protruding portions extending radially and connected to one or more neighbouring sub-components at a bonded interface. The outer surface may further include a recessed portion defining a cavity between the sub-components. The recessed portion may be between the first and second protruding portions.

In an embodiment, the plurality of bonded sub-components including the protruding portion and recessed portions endow the sintered component advantageously with more complex internal detailing including narrower and non-linear internal passages.

Optionally, the protruding portions tesselate at their respective bonding interfaces such that the cavity forms a second passage perpendicular to the central axes A.

Optionally, the bonding interfaces are sealed and continuous such that the first passage and/or the second passage are separate and fluid tight. Further, optionally the sintered component is the core for a heat exchanger wherein the first passage is configured to provide a first fluid flow path, and the second passage is configured to provide a second fluid flow path separate and perpendicular to the first fluid flow path.

Optionally, each sub-component has a polygonal cross section extending along the axis A, advantageously providing a good location for bonding faces at the bonding interface improving the strength of the bonded interface.

Optionally, the inner surface and/or outer surface of one or more of the sub-components includes further protrusions also called functional structures for increasing surface area or adjusting fluid flow characteristics such as fins, complex fins, protrusions, or triply periodic minimal structures.

Optionally, the sintered component further includes a non-powder process structure within the first passage and/or second passage bonded to the inner surface or outer surface respectively for improving heat transfer or directing fluid flow. Further optionally, the non-powder process structure comprises a plurality of foil sheets arranged in the first passage or second passage.

In some embodiments a non-powder process structure improves the strength and or provides improved surface area for heat transfer to the sintered component.

Optionally, the sintered component is a cellular structure, each of the sub-components forms a cell and said cellular structure comprises a plurality of non-uniform cells arranged to optimise fluid flow in the second passage.

Optionally, each sub-component comprises a polygonal wall extending between the inner surface and the outer surface, a first aperture having a first perimeter at the first end and a second aperture having a second perimeter at the second end connected by the first passage, the first protruding portion, extending from the first perimeter and the second protruding portion extending from the second perimeter to the bonding interface wherein the bonding interface has a polygon cross-section.

Optionally, wherein the powder material is a pure metal, alloy, ceramic, or composite that can be sintered.

### BRIEF DESCRIPTION OF DRAWINGS

Embodiments will now be described, by way of example only and with reference to the accompanying drawings having like-reference numerals, in which:

FIG. 1 shows the method of the current invention;

FIG. 2 shows a second aspect of the method of the current invention;

FIG. 3 shows a third aspect of the method of the current invention; and

FIG. 4 shows a fourth aspect of the method of the current invention;

FIG. 5 shows the steps in the method of the current invention;

FIG. 6 shows a sintered component with a uniform structure constructed according to the current invention;

FIG. 7 shows a sintered component with a non-uniform structure according to the current invention.

FIG. 8 shows a sub-component of a sintered component according to the current invention;

FIG. 9 shows functional structures included in a sub-component according to the current invention.

FIG. 10 shows functional structures that are triply periodic minimal structures according to the current invention.

FIG. 11 shows functional structures that are variable density triply periodic minimal structures according to the current invention.

FIG. 12 shows a heat exchanger according to the current invention; and

FIG. 13 shows fluid flow paths through a heat exchanger according to the current invention.

### SPECIFIC DESCRIPTION

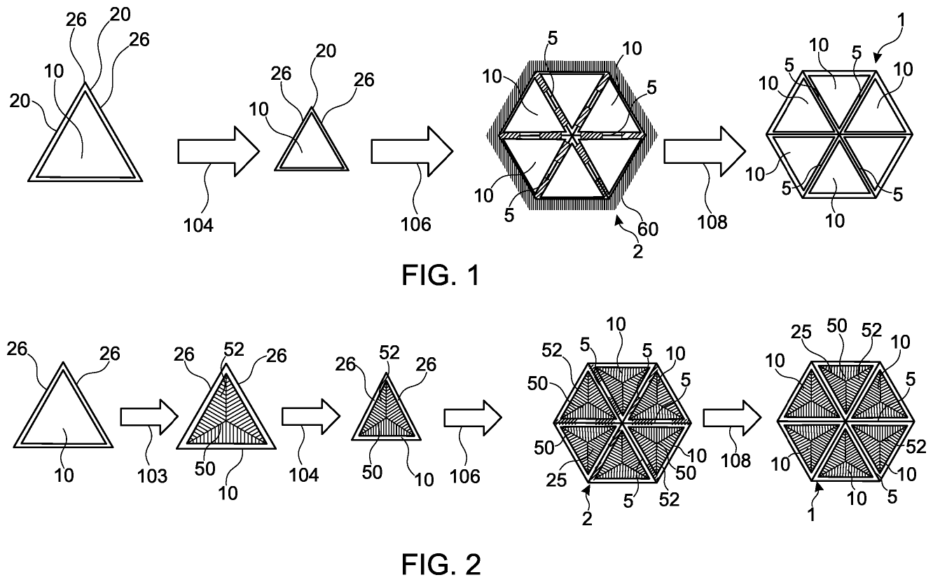

The current invention provides a method of manufacturing a homologous, unitary, sintered component 1 composed of a plurality of smaller sub-components 10 by co-sintering in a series of sequential steps as described below and shown in FIGS. 1 to 4.

Firstly, a plurality of sub-components 10 are made 100 in the form of a shaped powder preform 10a of the desired geometry with between 50 and 99.5% density. This may be achieved by producing a green body powder component 10a by an indirect additive manufacturing process 100 whereby powder material particles 3 are bonded together using a binder 4 to produce a shaped powder preform 10a. The shaped powder preform 10a in this state known as a green body compact 10a may then de-bound 102 to form a brown body compact 10b by partial removal of the binder 4, alternatively if a functional binder 4 is used the de-binding step 102 can be omitted avoiding the green body stage.

Secondly, the sub-components 10 are then at least partially sintered by the application of heat, in a first heating step 104. The heating process causes shrinkage as diffusion between the powder particles causes them to coalesce and sinter together.

Thirdly, the plurality of sub-components 10 are assembled to form an assembly of sub-components 2.

Finally, a unitary component 1 is formed from the plurality of individual sub-components 10 of the assembly of sub-components 2 by further application of heat in a second heating step 108. The second heating step 108 further sinters the assembly of sub-components 2 to bond the sub-components 10 together to form a unitary sintered component 1. The sub-components 10 have bonding faces 26 that are complementary to bonding faces 26 on one or more other sub-components 10. The sub-components 10 are assembled 106 so that the bonding faces 26 of neighboring sub-components 10 are in intimate contact during the sintering process of the second heating step 108. Thereby the powder compacts sinter together to form a whole as the powder particles at the surface sinter to one another. The bonding faces 26 are complementary in that they mate closely over the full area of the bonding face 26 to allow the bonding faces 26 to bond by sintering.

Referring to FIG. 1 a first embodiment of the invention will now be described. In FIG. 1 a sinter assemble sinter process is shown with the following stages:
a) The green sub-components 10, 10a are de-bound to give brown sub-components 10,10b
b) The brown components 10, 10b are sintered 104 to full density or close to full density, typically 98-100%
c) The sintered sub-components 10 are assembled 104. Optionally, extra powder 3, or a powder 3 and binder 4 mix may be inserted at the bonding interfaces to improve bonding.
d) The assembly is brought back to high temperature in a second heating step 108 to sinter the bond interfaces 5

The production of the homogenous, unitary, sintered component 1 is shown at various stages of its production moving sequentially from left to right. On the left side is shown one of a plurality of sub-components 10 created 100 using a high resolution, additive, powder bed manufacture technique 100a such as binder jetting additive manufacturing 100b. The sub-component 10 is a shaped powder preform 10a created from a powder material 3 and a binder 4. The powder material 3 is a pure metal, alloy, ceramic, or composite that can be sintered. In FIG. 1 the left drawing shows the sub-component 10 that has been partially debound to give a brown sub-component 10b. This involves the removal of a portion of the binder 4 leading to an increase in the percentage of the powder material 3 in the final component 1. In an alternative embodiment, the binder 4 used for the sub-component 10 may be a functional binder 4 suitable for inclusion in the final product 1. In this case debinding of the sub-component 10 is not required.

Once created the plurality of sub-components 10 are heated in a first heating step 104 to sinter the sub-component 10. The first heating step 104 may fully sinter the sub-component 10 or at least partially sinter 104 the sub-component 10. During sintering in the first heating step 104 the sub-component 10 shrinks causing stresses within the sub-component 10. The size of the sub-component 10 must be limited to prevent these stresses from causing the sub-component 10 to fail or fracture. Preferably, the sub-component is less than 60 mm in any one dimension.

The plurality of sub-components 10 are then assembled 106 to form an assembly of sub-components 2. The sub-components 10 include an outer surface 20 which includes one or more bonding faces 26 configured to interface with at least one of the one or more bonding faces 26 of a neighbouring sub-component 10 at one or more bonding interfaces 5. The assembly of sub-components 2 may include further powder material 3 or powder material 3 and binder 4 between the sub-components 10 where they meet for promoting bonding during the second heating step 108. Preferably once sintered the component 1 is homogenous at the bonding interfaces 5.

Once assembled the assembly of sub-components 2 is heated in a second heating step 108 to bond the sub-components 10 together at the bonding interfaces 5 to give the unitary sintered component 1. This step may also be referred to as co-sintering 108. The second heating step 108 may also further sinter the sub-components 10 and the additional powder material 3 and binder 4 if included.

FIG. 2 shows the method of FIG. 1 with the additional step of placing 107 the assembly of sub-components 2 in a fixture 60 after the assembly step 106, to constrain the assembly of sub-components 2 during the second heating step 108, with the following steps:
a) The green components are de-bound to give brown components
b) The brown components are sintered to a higher density, typically between 95-99%.
c) The partially sintered components are assembled in a fixture
   i. The fixture is selected so it has a lower coefficient of thermal expansion than the part material
   ii. An anti-diffusion coating may be applied to the fixture to allow it to be re-usable
   iii. Extra binder, or powder/binder mix may be inserted at the bonding interfaces
d) The assembly is brought to high temperature to sinter
   i. The fixture does not expand with temperature, applying a load on the bonding interfaces which improves sintering

The fixture 60 constrains the assembly of sub-components 2 during the second heating step 106. Preferably, the coefficient of thermal expansion of the fixture 60 is lower than the coefficient of thermal expansion of the assembly of sub-components 2 so that the fixture 60 exerts a compressive force on the assembly of sub-components 2 during the second heating step 108 as the assembly of sub-components 2 expands within the fixture more with the heat of the second heating step 108 than fixture 60.

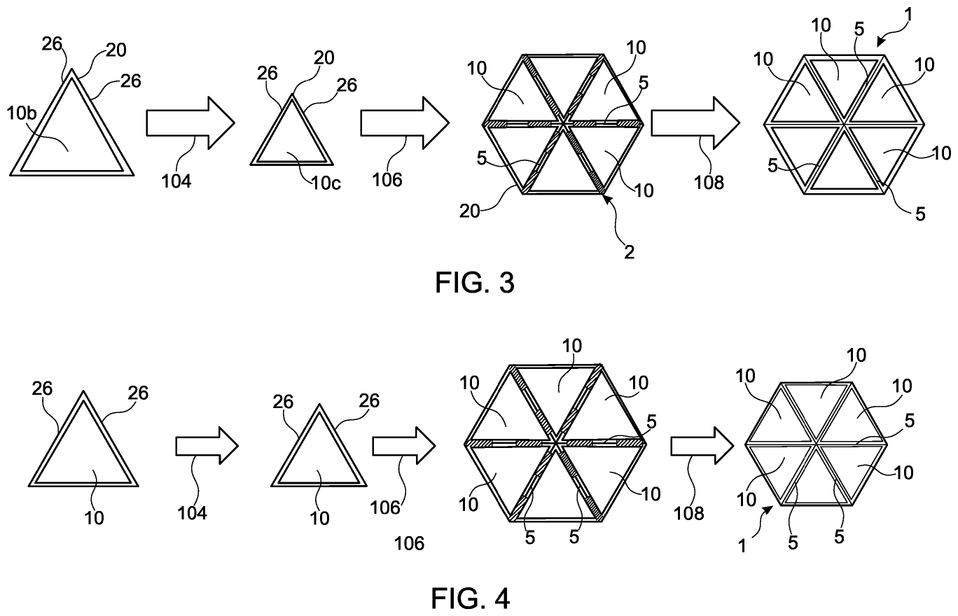

FIG. 3 shows the method of FIG. 1 wherein the sub-component 10 is only partially sintered during the first heating step 104 and further sintered during the second heating step 108 with the following steps:
a) The green components are de-bound to give brown components
b) The brown components are partially-sintered to a high density, typically 80-95%.
c) The sintered components are assembled with extra powder, or a powder/binder mix may be inserted at the bonding interfaces
d) The assembly is brought back to high temperature to sinter the interfaces

FIG. 4 shows the method of FIG. 1 with the further step of the addition 103 of a non-powder structure 50 to the sub-component 10. A non-powder structure 50 is a structure not formed by a powder process through sintering, such as a homogenous metal which may be rolled in the form of a foil structure 52, cast or forged. The non-powder structure 50 may be added to the sub-component 10 before the first heating step 104 and bonded to the sub-component 10 during the first heating step 104 as shown in FIG. 4. Alternatively, the non-powder structure 50 may be added 103 during the assembly 106 of the assembly of sub-components 2 and bonded to the sintered component 1 during the second heating step 108.

The non-powder structure 50 may be located inside a cavity 30 of the sub-component 10 or situated between sub-components 10. The non-powder structure 50 is bonded to the sub-component 10 or the component 2 by diffusion bonding or held in place by the sub-component 10 shrinking around the non-powder component 50 due to shrinkage from sintering during the first heating step 104 or the second heating step 108. The process of FIG. 4 has the following steps:
a) The green components are de-bound to give brown components
b) Foil structures are inserted into voids within the heat exchanger
c) The components with foil structures are partially-sintered to a high density, typically 80-95%, which constrains the foil structures and allows diffusion bonding
d) The sintered components are assembled with extra powder, or a powder/binder mix inserted at the bonding interfaces
e) The assembly is brought back to high temperature to sinter the part-part interfaces

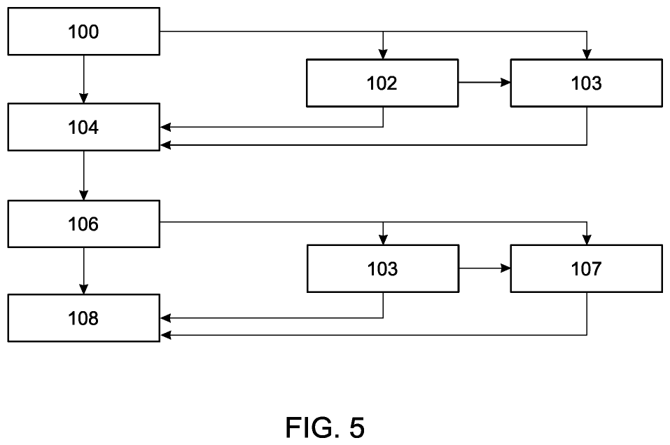

FIG. 5 shows the steps of the process.

FIGS. 1 to 4 all show a sub-component 10 with a triangular cross section and six of said sub-components 10 assembled 102 to form an assembly of sub-components 2. It will be understood that each sub-component can be any shape that includes one or more bonding faces 26 that form a complementary interface with neighbouring sub-components 10 in the assembly of sub-components 2 to allow the sub-components 10 to be joined during the second heating step 108. In a particularly beneficial configuration, the sub-components 10 have a polygonal cross section and planar bonding faces 26 to facilitate a secure bond between sub-components 10 in the sintered component 1. However, the benefit of additive manufacturing is that any shape is possible. The method of the current invention can be used for regular and irregular shaped sub-components 10 with complementary bonding faces 26 configured to mate at a bonding interface 5.

The co-sintering step 108 may be aided by the application of a force to the bonding faces 26 during the sintering process 108. This can be provided in a number of ways.
The design of the sub-components 10 may be such that gravity acts on some or all of the bonding interfaces 5 during the second heating step 108.
a fixture 60 may be used to constrain the sub-components 10 during the second heating step 108, as described by reference to FIG. 2 above, so that a compressive force is applied across the interface.
The design of structures by additive manufacturing to interlink the bonding surfaces through non-planar structures, or by separate inserts that hold parts in intimate contact during sintering.

The fixture 60 may include an anti-diffusion coating 62 to prevent adhesion of the component 1 to the fixture by either sintering or diffusion bonding.

The powder material 3 may be a ceramic or metallic material according to the specific application needs. Current available metals that are suitable for use in the method include nickel superalloys, steel alloys, copper alloys, aluminium alloys, and titanium alloys. The method is not limited to these metals, and may be applied to any pure metal, alloy, ceramic, or composite which can be sintered.

The method overcomes the size limitation associated with the sintering process of powder bed manifested parts, including binder jetted parts. The multiple individually manufactured sub-components 10 are brought together 106 and creates a homologous unitary sintered component 1 following co-sintering 108. The plurality of sub-components 10 means internal surfaces of the final component 1 are accessible during manufacture allowing incorporation of geometric features on said internal faces that could not be manufactured otherwise due to difficulties in moulding and powder extraction.

The method allows the combination of high resolution features at a micro meter scale on a macroscale component at low cost with minimal intervention.

The method of the current invention is particularly suited to the manufacture of complex heat sinks and high efficiency fluid to fluid heat exchangers 7 for transferring thermal energy between a liquid and a gas, two liquids, or two gases. Using traditional manufacturing techniques such heat sinks and heat exchangers are limited in efficiency as discussed above and to simple forms such as six sided polyhedra and are usually flat rectangular prisms. If shaping is required heat exchangers are limited to very slight curvature in a single plane, normally created by bending a flat heat exchanger post production. The method of the current invention allows complex sintered heat exchangers 7 to be produced of any size and shape, tailored to the local flow characteristics and direction as well as the space available.

A sintered component 1 according to the current invention comprises a plurality of sub-components 10 sintered together to form a unitary sintered component 1. Each of the sub-components 10 having an outer surface 20 which includes one or more protruding portions 22, 24 having one or more bonding faces 26. Each of the bonding faces 26 are configured to interface with one or more complementary bonding faces 26 of one or more neighbouring sub-components 10 in the sintered component 1 at a bonding interface 5. The outer surface 20 further includes a recessed portion 28 for defining a cavity 30 in the sintered component 1 between sub-components 10. The recessed portion 28 is between the first and second protruding portions 22, 24. The cavity 30 may be closed or open on one or more sides to allow flow of fluid through the cavity 30.

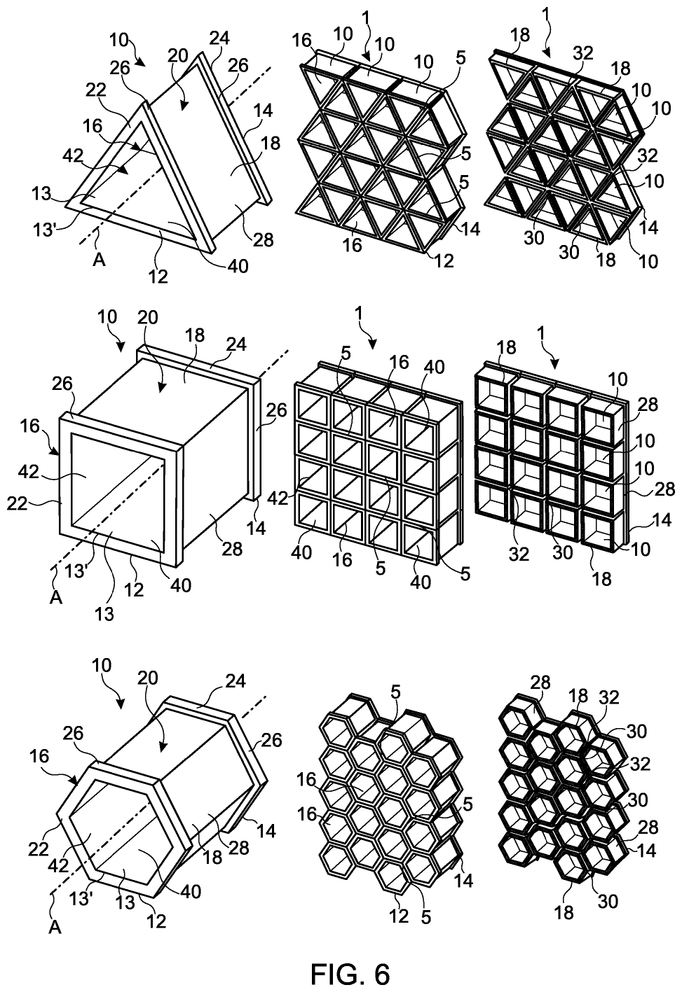

FIG. 6 shows a configuration of such a sintered component 1 in the form of a heat exchanger 7. The sintered component 1 comprises a plurality of sub-components 10 each forming a cell 16 of a heat exchanger 7. In the embodiment of FIG. 6 each of the sub-components 10 are in the form of a polygonal prism with a first end 12 and a second end 14 and an inner surface 40 defining a first passage 42 extending through the sub-component from the first end 12 to the second end 14. The first passage 42 defining a central axis A extending there through from the first end 12 to the second end 14. The sub-component 10 further including an outer surface 20 having one or more bonding faces 26 configured to interface with complementary bonding faces 26 on one or more neighbouring sub-components 10 of the sintered component 1. Each sub-component 10 comprises a wall 18 extending between the outer surface 20 and the inner surface 40.

Each sub-component 10 includes an outer surface 20 that includes bonding faces 26 configured to interface with complementary bonding faces 26 of neighbouring sub-components 10 at a bonding interface 5. In a preferred embodiment the outer surface 20 includes a first protruding portion 22 extending radially at the first end 12 and a second protruding portion 24 extending radially at the second end 14. Preferably the first protruding portion 22 and the second protruding portion 23 extend radially outwardly from the outer surface 20 and/or wall 18 of the first passage 42 in a direction R. The first protruding portion 22 and the second protruding portion 23 may extend radially outwardly perpendicular to the inner surface 40 and/or the axis A. Each radially extending portion 22, 24 including external planar faces 23 which define a polygon in cross section and wherein the external planar faces 23 are the bonding faces 26.

In an alternative embodiment bonding faces 26 may not be planar and may include complementary protruding and intruding features 27 to improve location and bonding strength between the sub-components 10.

The outer surface 26 further includes a recessed portion 28 which forms a cavity 30 between the sub-components 10 when the sub-components 10 are assembled. When the sintered component 1 is a heat exchanger 7, as in FIG. 6, the protruding portions 22, 24 are tessellating protruding portions 22, 24 that tesselate in that they fit together without gaps at the bonding interface 5 to form a continuous fluid tight join and the cavity 30 forms a second passage 32. Thus, the first passage 42 is a first fluid flow path 44 and the second passage 32 is a second fluid flow path 34 for exchanging heat energy between a first fluid and a second fluid. The first fluid flow path 35 and the second fluid flow path 45 being fluid tight and separate to one another. The first fluid flow path 35 and therefore Axis A being perpendicular to the second fluid flow path 45.

In a preferred embodiment each sub-component 10 comprises a wall 18 extending between the outer surface 20 and the inner surface 40. The wall 18 having a polygonal cross section.

In the case of a heat exchanger 7 each sub-component 10 includes a first aperture 13 having a first perimeter 13′ at the first end 12 and a second aperture 15 having a second perimeter 15′ at the second end 14. The first aperture 13 and the second aperture 15 connected by the first passage 42 along axis A. The first protruding portion 22 may extend radially outward from the full length of the first perimeter 13′ and the second protruding portion 24 may extend radially outward from the full length of the second perimeter 15′ to their respective bonding interfaces 5. The bonding interface 5 may also have a polygonal cross section.

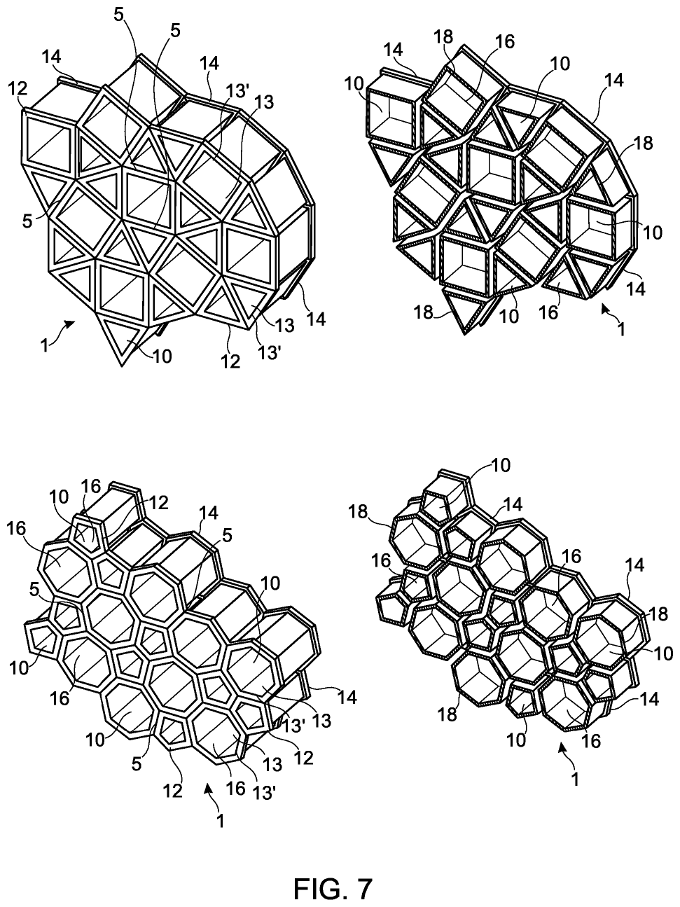

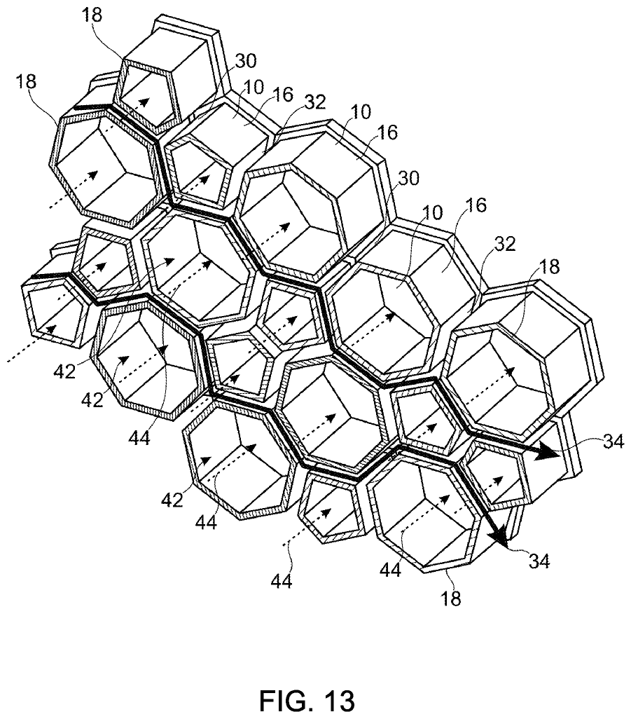

In more complex arrangements such as those shown in FIG. 7 the sub-components 10 can be non-uniform or irregular to tailor and/or optimise multiple fluid flow paths 35, 45 through and between the cells 16 of the heat exchanger 7. For example, the polygonal prismal sub-components 10 may be of a different number of sides, of differing sizes, or the polygonal profile may be an irregular shape. The profile of the sub-components 10 may be configured to straighten the second fluid flow path 45 by reducing the angle θ through which fluid must turn to increase flow. Alternatively, the profile of sub-components 10 may be configured to increase the angle θ through which fluid must turn and or increase the distance fluid must take through the heat exchanger 7 to increase heat transfer. An example of the fluid flow paths is shown in FIG. 13.

Individual cells 16 can be shaped by design to provide curvature to the component 1 to fit conformably within a prescribed space, such as around a cylindrical core, or with a second degree of curvature. If a curved profile is required for the heat exchanger 7 the sub-components 10 may be tapered in one or more directions along axis A to provide a sintered component 1 with single or compound curvature without introducing stresses into the component 1 by bending after manufacture. Even if an irregular pattern is chosen, cells 16 may be combined into modules by means of repeating the base cell 16 or combination of cells 16 such that they tesselate easing manufacture.

A geometry may be broken down into repeating groups of sub-components for ease of manufacture. These groups create a tessellation of shaped geometries to provide internal geometries at the modular level, although this is not necessary.

In the example of a fluid heat exchanger, particular advantages may be provided relating to how the method enables the manufacture of heat transfer structures and flow management structures by shaping of the internal fluid paths.

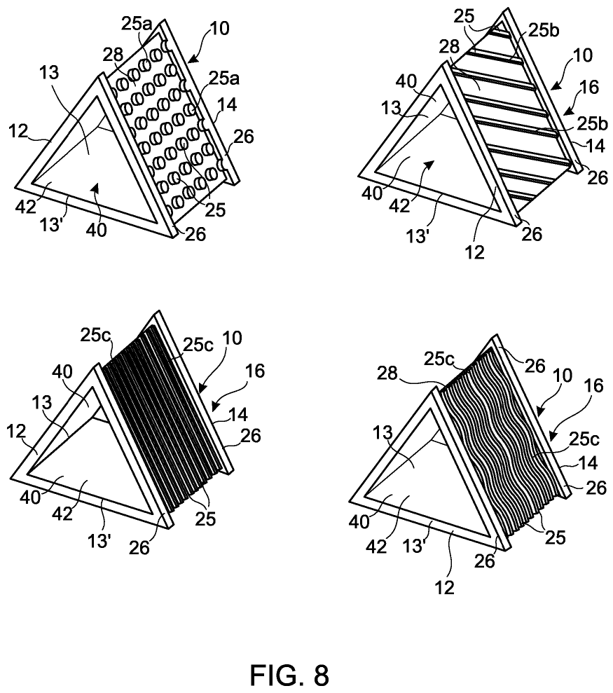

In FIG. 8 examples of functional structures 25 are shown in the form of further protrusions 25 for disrupting fluid flow and increasing surface area for heat transfer. FIG. 8 shows said functional structures 25 on the outer surface 20 protruding therefrom into the second passage 32 for increasing surface area for heat transfer and/or adjusting flow characteristics of the fluid flowing in the second passage 32 or second fluid flow path 34. In a further aspect of the current invention the functional structures 25 may be located on the inner surface protruding therefore into the first passage 42 for increasing surface area for heat transfer and/or adjusting flow characteristics of the fluid flowing in the first passage 42 or first fluid flow path 44. These further protrusions 25 can be formed during creation 100 of the powder preform as part of the green body 10a and can be located on the outer surface 20 and or inner surface 40 of a sub-component 10. These further protrusions 25 can be in the form of flow-disrupting and surface area increasing structures 25 such as pins 25a, ribs 25b and fins 25c to improve thermal transfer.

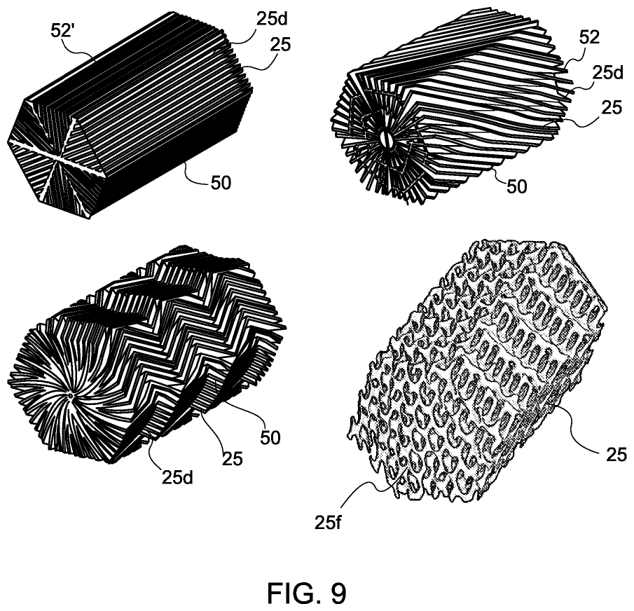

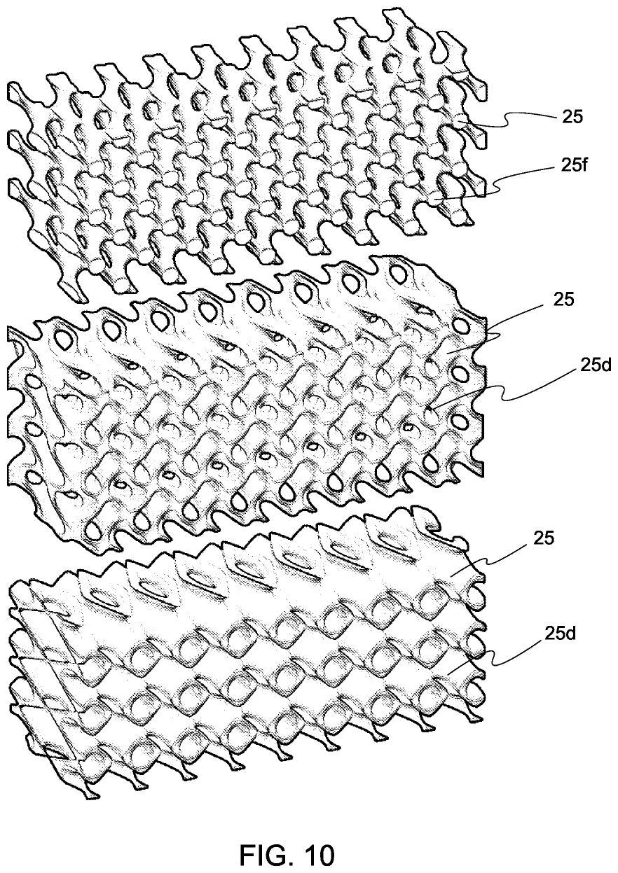

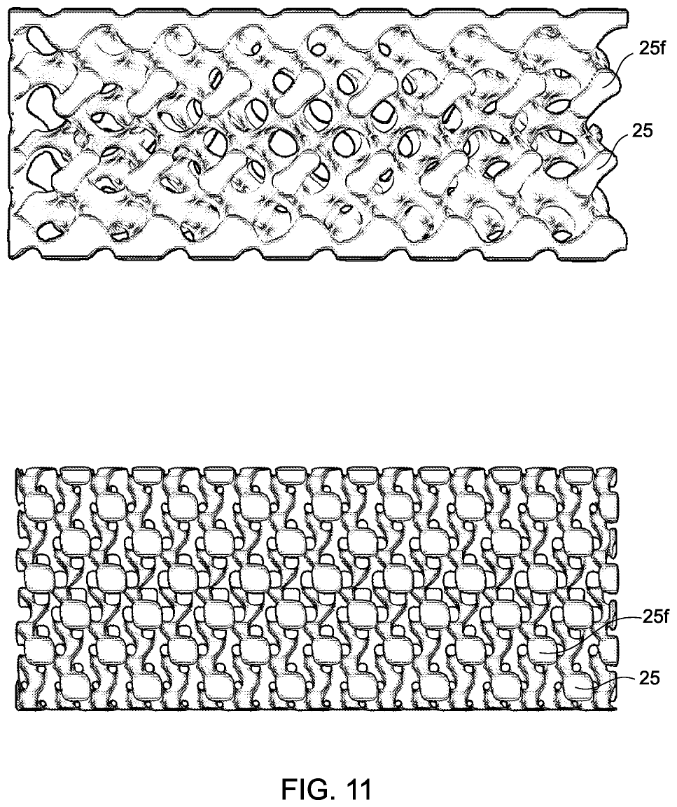

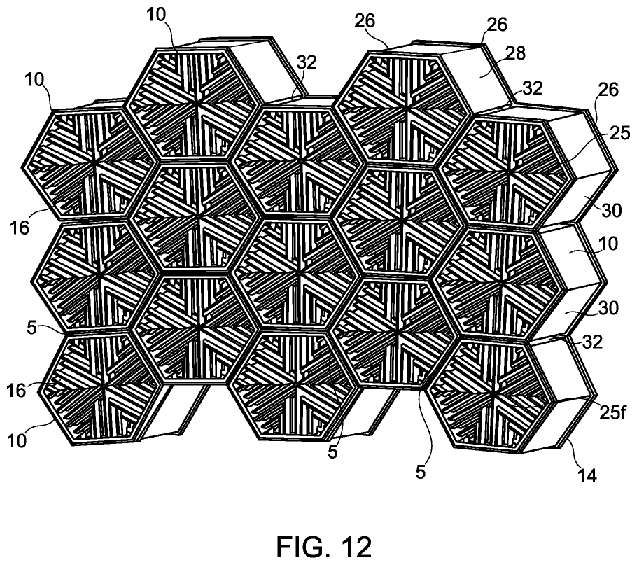

The method of the current invention also allows more complex functional structures 25 to be included in or added to the sub-component 10 for improved thermal transfer through increased surface area or by modifying or disrupting fluid flow in the passages 32, 42. For example in a fluid-fluid heat exchanger 7, particularly where one fluid is gaseous and the other liquid, the optimum surface contact area for the two fluids may differ widely for best heat transfer. For such a situation, the liquid channels may be the second fluid flow path 34 around the outside of cell 16, and functional structures 25 including high complexity gas-facing surfaces 27 with high surface area to volume ratios may be included in the first fluid flow path 34. Such functional structures 25 are shown in FIGS. 9 and 10 can be in the form of complex fin-type structures 25d, pin array type structures 25e, and periodic minimal surfaces 25f. These periodic minimal structures 25f may be of variable density as displayed in FIG. 11, ideally having a reduced density, having larger apertures, towards the middle of the passage 32, 42 and a higher density with smaller apertures closer to the inner and or outer surface.

The functional structures shown in FIG. 9 are designed to be included in the first passage 42 of a cell 16 with a hexagonal cross section.

These gas-facing surfaces may be sintered structures formed by a powder process such as binder jetting or may be non-powder structures 50 produced by bulk additive manufacturing techniques. Binder jetting of these complex functional structures, in particular, metal binder jetting, allows a high degree of design freedom, taking advantage of high complexity, thin walled structures such as periodic minimal surfaces having fine fin structures to perform their function. These structures can incorporate secondary functionality such as flow directing surfaces for maintaining ideal orientation for their function, or to be used to perform operations on a fluid such as controlling direction.

Any system feature, as described herein may also be provided as a method feature, and vice versa. As used herein, means plus function features may be expressed alternatively in terms of their corresponding structure.

Any feature in one aspect may be applied to other aspects, in any appropriate combination. In particular, method aspects may be applied to system or apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

1. A method for making a thin walled, sintered component, comprising:
creating a plurality of sub-components using binder jetting additive manufacturing, said sub-components comprising a shaped powder preform, including a powder material and a binder;
the sub-components having an outer surface including one or more protruding portions having one or more bonding faces configured to interface with at least one of the one or more bonding faces of a neighbouring sub-component;
heating the plurality of sub-components in a first heating step to at least partially sinter the sub-components;
assembling said sub-components to form an assembly of sub-components, having one or more bonding interfaces where the bonding faces of adjacent sub-components meet,
heating the assembly of sub-components in a second heating step to bond the sub-components together to form the component.

2. The method of claim 1, wherein thin walled comprises a wall thickness of less than 2 mm.

3. The method of claim 1, wherein the first heating step comprises partially sintering the sub-component and the second heating phase further sintering the component.

4. The method of claim 1, wherein the first heating step comprises fully sintering the sub-components.

5. The method of claim 1, wherein the sub-components further include a recessed portion for defining a cavity, in the sintered component, between sub-components.

6. The method of claim 1, wherein the sub-components further include an inner surface defining a first passage, a first end and a second end; wherein the first passage extends from said first end to said second end through the sub component, and having a central axis A extending from the first end to the second end.

7. The method of claim 6, wherein the sub-component includes a first protruding portion of the respective sub-component extends radially at or near the first end and a second protruding portion of the respective sub-component extends radially at or near the second end, and said protruding portions tesselate at their respective bonding faces in the sintered component such that the cavity forms a second passage perpendicular to the central axes A.

8. The method of claim 1, wherein the second heating step includes sealing the bonding interface between the sub-components such that the first passage and/or the second passage are individually fluid tight.

9. The method of claim 1, further including creating the protruding portions having external planar faces defining a polygon in cross section and said external faces are the bonding faces.

10. The method of claim 1, further including the step of partially debinding the sub-components before the second heating step.

11. The method of claim 1, wherein the assembly of sub-components further includes adding a bonding material at the bonding interfaces between the sub-components before the second heating step.

12. The method of claim 11, wherein the bonding material comprises further powder material or a mixture of further powder material and further binder.

13. The method of claim 1, including adding a non-powder processed structure to the sub-component before assembly of the sub-components to form the assembly of sub-components.

14. The method of claim 13, wherein the non-powder structure is a foil structure.

15. The method of claim 13, wherein the adding of the non-powder structure includes a supplementary heating step for bonding the non-powder structure to the sub-component.

16. The method of claim 1, including applying a compressive force to the bonding interfaces between the sub-components during the second heating step.

17. The method of claim 16, wherein the bonding faces of the sub-components are arranged such that gravity provides said compressive force.

18. The method of claim 1, wherein the assembly of sub-components is placed in a fixture for the second heating step.

19. The method of claim 18 wherein the fixture has a coefficient of thermal expansion lower than the material of the component for providing the compressive force at the bonding interfaces.

20. The method of claim 18, wherein the fixture includes an anti-diffusion coating to prevent adhesion of the component to the fixture.

21. The method of claim 1 wherein the sub-components are sintered to 80-100% of full density during the first heating step or to 98-100% of full density during the first heating step or to 80-95% of full density during the first heating step or to 95-99% of full density during the first heating step.

20-24. (canceled)

25. The method of claim 1, wherein the powder material is a pure metal, alloy, ceramic, or composite that can be sintered.

26-36. (canceled)
